(19) United States
(12) Patent Application Publication
(10) Pub. No.: US 2024/0005197 A1
(43) Pub. Date: Jan. 4, 2024

(54) METHOD AND SYSTEM FOR GENERATING AI TRAINING HIERARCHICAL DATASET INCLUDING DATA ACQUISITION CONTEXT INFORMATION

(71) Applicant: Korea Electronics Technology Institute, Seongnam-si (KR)

(72) Inventors: Kyoung Won MIN, Seongnam-si (KR); Haeng Seon SON, Seongnam-si (KR); Seon Young LEE, Seoul (KR); Young Bo SHIM, Seongnam-si (KR); Chang Gue PARK, Seongnam-si (KR)

(73) Assignee: Korea Electronics Technology Institute, Seongnam-si (KR)

(21) Appl. No.: 17/623,132

(22) PCT Filed: Dec. 29, 2020
(86) PCT No.: PCT/KR2020/019273

§ 371 Date: Sep. 20, 2023

(30) Foreign Application Priority Data
Dec. 28, 2020 (KR) 10-2020-0184210

(51) Int. Cl. G06N 20/00

(52) U.S. Cl. CPC G06N 20/00

(57) ABSTRACT

Provided are a method and a system for generating an AI training hierarchical dataset including data acquisition context information. A GT dataset generation method according to an embodiment of the present disclosure includes: acquiring and storing vehicle data; acquiring and storing sensor data generated at a sensor installed in a vehicle; and generating and storing context information which is information regarding a context at a time when the data is acquired. Accordingly, in generating a GT descriptor, various contexts, conditions at the time when data is acquired may be made to be easily analyzed, classified on the GT descriptor through a hierarchical dataset, which hierarchically describes context information at the time when sensor data is acquired on the descriptor, so that an AI network is effectively trained, and eventually, has high recognition performance.

### TECHNICAL FIELD

The present disclosure relates to technology for generating a ground truth (GT) dataset for training, and more particularly, to a method for automatically generating a dataset necessary for training an artificial intelligence (AI) network of deep learning or machine learning for autonomous driving.

### BACKGROUND ART

In training an AI network, various methods may be used, and a representative method thereof may be a supervised learning method.

In this method, one dataset is configured by marking a ground truth (GT) having a true value on the same coordinates system as a sensor signal acquired in specific context and condition (2D or 3D information obtained by a camera, a LiDAR and having a characteristic of being changed by an input to a typical sensor, or radar, sound obtained by other sensors), and a supervised learning process, which inputs a sensor signal to the AI network and compares a result of determining by the AI network with the GT, is repeatedly performed until an error is reduced to be less than or equal to a specific value, and finally, this method trains main parameters of the AI network.

The AI training dataset used in the supervised learning method is provided as a pair of GT and sensor input information which is described in the form of a descriptor by using a description language, such as XML, JSON, as shown in FIG. 1.

However, characteristics and performance of the AI network are typically determined depending on how much of training dataset is appropriately inputted and is used for training according to each condition (weather, illumination, a specific region/road condition, or a condition on whether passersby walking, running or sitting are included, or a specific vehicle moving in a specific direction or stopping is included or not included), or each context (congestion, an accident).

Although learning performance of the AI network is greatly influenced by a condition, a context of a dataset, the existing training dataset is configured only by describing a GT descriptor on input sensor information in pair. Therefore, it may be impossible to distinguish an acquisition condition, context information, and it may be difficult to train effectively the AI, and there may be a problem that the AI network should learn while repeatedly changing a learning condition according to user's experiences.

### DISCLOSURE

### Technical Problem

The present disclosure has been developed in order to address the above-discussed deficiencies of the prior art, and an object of the present disclosure is to provide a solution for effectively training an AI network and allowing the trained AI network to have high recognition performance, by making it possible to easily analyze, classify a context, a condition at the time when sensor data is acquired on a GT descriptor, in order to overcome limitations of an existing dataset, and specifically, an object of the present disclosure is to provide a method and a system for generating a hierarchical dataset, which hierarchically describe context information at the time when sensor data is acquired on a descriptor when generating a GT descriptor.

### Technical Solution

According to an embodiment of the present disclosure to achieve the above-described object, a GT dataset generation method includes the steps of: acquiring and storing vehicle data; acquiring and storing sensor data generated at a sensor installed in a vehicle; and generating and storing context information which is information regarding a context at a time when the data is acquired.

An area in which the context information is stored may be positioned on an upper area of an area in which the vehicle data is stored, an area where the sensor data is stored, and an area where an annotation is stored.

In addition, the context information may be information that is referred to when the context at the time when the data is acquired is reconstituted.

The step of generating and storing the context information may include generating the context information by synthetically analyzing the sensor data.

The context information may include information regarding an address of an administrative district where the data is acquired, a road environment, a date, a weather condition.

The vehicle data may include information regarding the vehicle and information regarding sensors mounted in the vehicle, and the step of storing the sensor data may include synchronizing the sensor data sensed by the sensors through at least one of interpolation, up-sampling and down-sampling, and storing the sensor data.

According to an embodiment of the present disclosure, the GT dataset generation method may further include a step of acquiring and storing GT information regarding the sensor data, a step of acquiring and storing an annotation may include acquiring the GT information which is manually correctable after generating by using an AI network which receives sensor data and infers GT information.

According to another embodiment of the present disclosure, a GT dataset generation system includes: an acquisition unit configured to acquire vehicle data and to acquire sensor data generated at a sensor installed in a vehicle; a processor configured to generate context information which is information regarding a context at a time when the data is acquired; and a storage unit configured to store the vehicle data and the sensor data acquired through the acquisition unit, and the context information generated by the processor.

### Advantageous Effects

According to embodiments of the present disclosure as described above, in generating a GT descriptor, various contexts, conditions at the time when data is acquired may be made to be easily analyzed, classified on the GT descriptor through a hierarchical dataset, which hierarchically describes context information at the time when sensor data is acquired on the descriptor, so that an AI network is effectively trained, and eventually, has high recognition performance.

### DESCRIPTION OF DRAWINGS

FIG. 1 is a view illustrating examples of a dataset in which a GT is marked on a sensor (image) input, and a GT descriptor;

FIG. 2 is a view illustrating a GT dataset hierarchical structure suggested in an embodiment of the present disclosure;

FIG. 3 is a view illustrating a hierarchical GT dataset generation method according to an embodiment of the present disclosure;

FIG. 4 is a view illustrating an automatic GT generation method;

FIG. 5 is a view illustrating a relationship between a superset class and a GT class; and

FIG. 6 is a hierarchical GT dataset generation system according to another embodiment of the present disclosure.

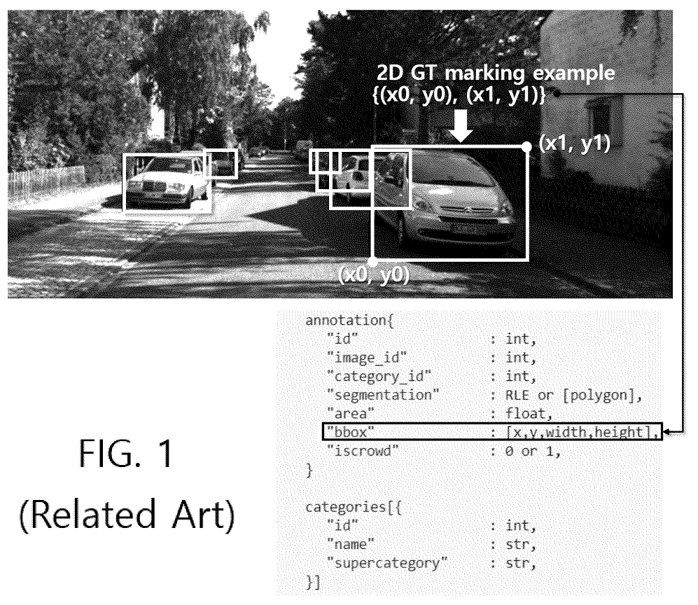

### BEST MODE

Hereinafter, the present disclosure will be described in more detail with reference to the drawings.

An AI network adopting a supervised learning method may show a high recognition rate, without falling into overfitting, when the AI network uniformly learns from datasets to classify in a learning process, and when the AI network appropriately learns even in various conditions and contexts where there exist datasets to classify.

In order to uniformly distribute the datasets to classify in the learning process and to perform learning in various conditions and contexts, classification information should be appropriately recorded in a process of generating the datasets, and the datasets should be able to be classified on a DB according to various conditions.

Accordingly, in embodiments of the present disclosure, when a GT descriptor is generated, information at the time when sensor data is acquired is hierarchically described on the descriptor, and a GT dataset is generated.

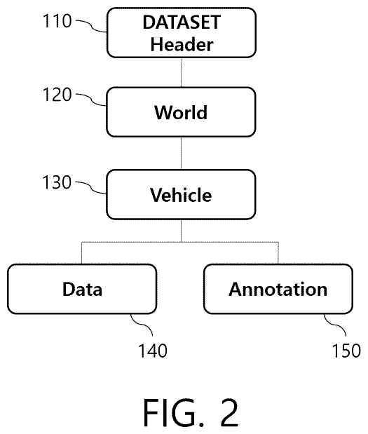

FIG. 2 is a view illustrating a hierarchical structure of a GT dataset (GT descriptor) suggested in an embodiment of the present disclosure.

The GT dataset suggested in the embodiment of the present disclosure has a hierarchical structure including a dataset header 110, world information 120, vehicle information 130, data 140, and an annotation 150.

The dataset header 110 is positioned on the top layer, and the world information 120, the vehicle information 130, and the data 140 and the annotation 150 are positioned on the next lower layers in sequence from the top layer.

The dataset header 110 includes license information, production institute information, and distribution-related information of the GT dataset.

The world information 120 is information that is referred to when a context at the time when data is acquired is reconstituted, and stores information regarding the context at the time when data is obtained, and specifically, includes the following information:

1) Acquisition area: This indicates a place where data is acquired, and is position information of a comprehensive superordinate concept to GPS information, and may utilize an address of an administrative district (si/do, gu, dong, myeon in the administrative district system of Korea).

2) Road environment: This is information regarding a type of a road where data is acquired, and is divided into a highway, a national highway, a cycle route, an unpaved road, others.

3) Acquisition date: This is a data at which data is acquired, and is generated in the form of YYYY MM DD based on GPS time information.

4) Weather condition: This is weather information at the time when data is acquired, and is generated based on a combination of dawn/daytime/nighttime, weather (sunny, cloudy, foggy, rainy, snowy), and may further include a specific weather condition (for example, precipitation requirements, precipitation of rainy weather).

The data acquisition context information stored in the world information 120 is generated based on comprehensive analysis of sensor data, which will be described below.

The vehicle information 130 stores information regarding a data acquisition vehicle (or device), and information regarding a sensor mounted therein, and specifically, includes the following information:
1) Model of a vehicle which acquires the dataset
2) Coordinates reference point of the vehicle acquiring the dataset
3) Standards link of a data acquisition sensor mounted in the vehicle
4) Sensor information
a sensor type, a mounting position, a mounting environment (angle, slope), the number of mounted sensors and characteristics of each sensor (a resolution, a view angle, a frequency, channel number, a operating frequency, etc.)
Sensor intrinsic, extrinsic parameter information for calibration
Storage data format for each sensor (raw, jpec, PCD, etc.)

The data 140 stores sensor data which is generated from a sensor installed in the vehicle, and is generated at the time when data of the sensor is acquired in order to estimate a physical variation in the data acquisition environment condition at the sensor data acquisition time, and specifically, includes the following data:
1) Year/month/day/hour/minute/second/millisecond of the data acquisition time based on GPS time information
2) x, y, z posture information of the vehicle at the data acquisition time
3) Acceleration/deceleration value of the vehicle at the data acquisition time
4) Steering value of the vehicle at the data acquisition time
5) Engine RPM and the number of gear stages of the vehicle acquiring the above-mentioned data
6) Sensor data file list acquired at the data acquisition time to link the variation and acquired data

The annotation 150 stores annotation information such as GT information regarding the sensor data, attribute information of each object, and specifically, includes the following information:
1) Path of the acquired sensor data
2) Type and index of the sensor data
3) GT type definition and GT information resulting therefrom (typical GT information described above, such as class ID, 2D/3D bbox coordinates, segmentation, etc.)
4) Attribute of an object (visibility, characteristic information)

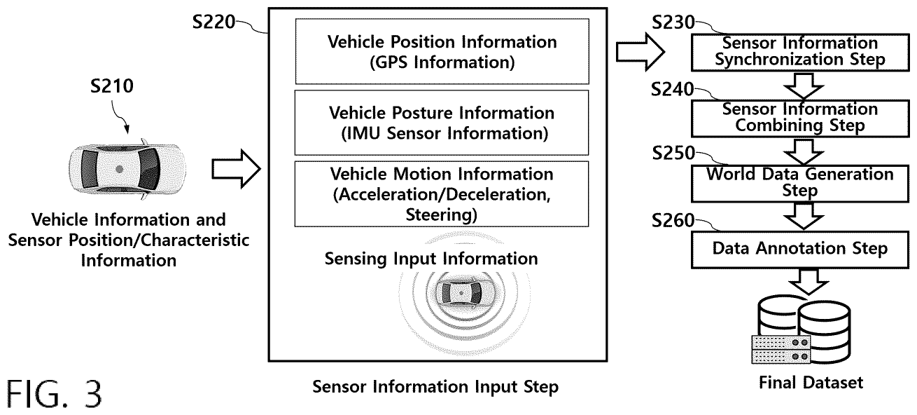

A process of generating the hierarchical GT dataset illustrated in FIG. 2 will be described in detail hereinbelow with reference to FIG. 3. FIG. 3 is a view provided to explain a method for generating a hierarchical GT dataset according to an embodiment of the present disclosure.

In order to generate the hierarchical GT dataset, license information, production institute information, and distribution-related information of the GT dataset are acquired first, and are stored in the dataset header 10 of the top layer, and then, information regarding a data acquisition vehicle (or device) and information regarding a sensor mounted therein are acquired and are stored in the vehicle information 130 (S210).

Next, sensor data (vehicle position information, vehicle posture information, vehicle motion information, etc.) generated in the sensor installed in the vehicle is acquired (S220), sensor data acquired in different acquisition periods are synchronized to have the same period by performing interpolation, up-sampling, or down-sampling with respect to the acquired sensor data (S230), and description information is generated by combining the synchronized sensor data on the same coordinates system and is stored in the data 140 (S240).

Thereafter, context information at the time when the data is acquired is generated by analyzing the sensor data stored in the data 140 at step S240, and the generated data acquisition context information is stored in the world information 120 (S250).

For example, a moving area of the vehicle is detected by collecting information on GPS coordinates of the vehicle, and the detected area is converted into an address of an administrative district. A moving section of the vehicle is detected, and a type of a road of the detected section is grasped. A data acquisition data is derived by collecting GPS time information, and weather condition information is acquired from a server of a weather center based on the acquisition date and the address of the administrative district

Next, GT information for sensor data that needs GT marking from among sensor data stored in the data 140 is generated and is stored in the annotation 150 (S260).

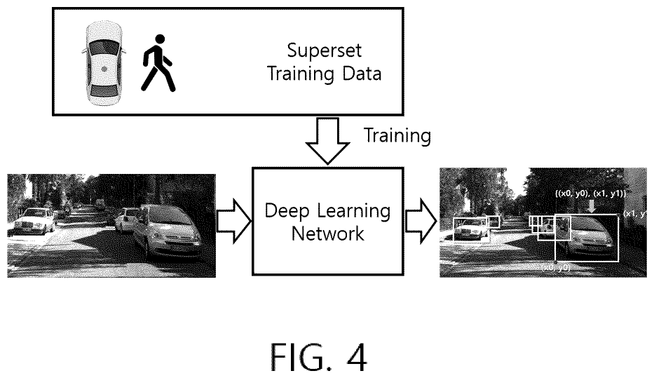

In this case, generation of the GT information through the annotation may be performed as follows: As shown in FIG. 4, a specific artificial intelligence (AI) network is trained by using a superset including a class of a dataset to annotate, and then, data to annotate is inputted to the corresponding network and the network is enabled to recognize information of an object corresponding to the dataset class from the input data according to the result of learning, and the GT of the dataset is extracted. When there is a need to supplement the GT information extracted in this process, the extracted GT may be updated by being manually corrected and supplemented.

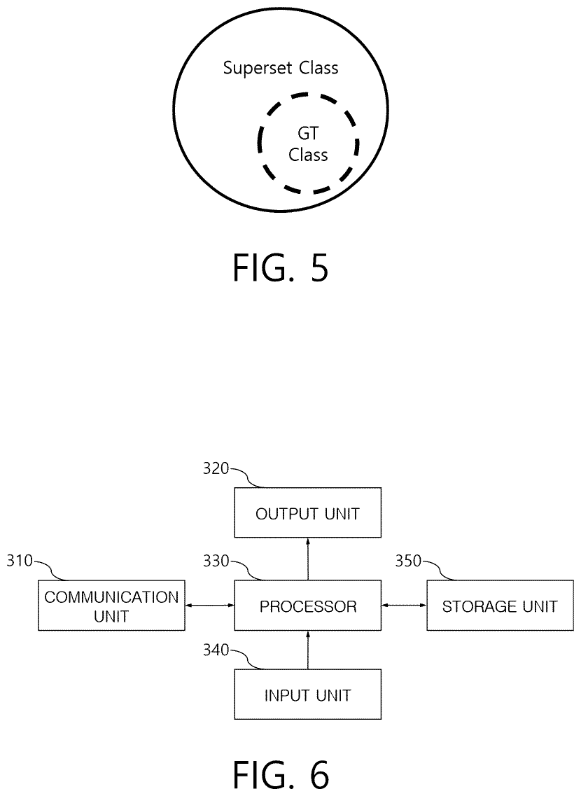

The superset class used for training the specific AI network may be implemented by a training dataset including a GT class, specifically, further including other classes in addition to the GT class, as shown in FIG. 5.

The GT dataset finally generated through the above-described process includes a variety of information such as information on an environment where data is acquired, a position, operations, etc., in addition to information of a type of an object and a position included in a typical GT descriptor. Accordingly, various contexts, conditions at the time when the data is acquired may be easily analyzed, classified on the GT descriptor, and finally, an AI algorithm may be effectively trained, and also, the trained AI algorithm may provide high recognition performance.

FIG. 6 is a block diagram of a hierarchical GT dataset generation system according to another embodiment of the present disclosure. The hierarchical GT dataset generation system according to an embodiment of the present disclosure may be implemented by a computing system which includes a communication unit 310, an output unit 320, a processor 330, an input unit 340, and a storage unit 350 as shown in the drawing.

The communication unit 310 is a means for connecting communication with a data acquisition vehicle (or device), and acquiring information and data necessary for generating a GT dataset, and the input unit 340 is a means for acquiring information and data necessary for generating the GT dataset through a user input.

The processor 330 performs the procedures shown in FIG. 3 by using tge information and the data which are acquired through the communication unit 310 and the input unit 340 to generate the hierarchical GT dataset having the structure shown in FIG. 2, and to store the generated GT dataset in the storage unit 350.

The output unit 320 is a display which displays processing by the processor 330 and results thereof.

Up to now, the method and system for generating the AI training hierarchical dataset including information at the time when data is acquired have been described in detail with reference to preferred embodiments.

Related-art technology is configured to describe only a GT descriptor on input sensor information in pair, and therefore, there may be a problem that it is difficult to identify an acquisition condition, context information and to train AI effectively.

However, in embodiments of the present disclosure, information at the time when sensor data is acquired may be effectively described on a hierarchically configured GT descriptor, and the information may be visualized. Accordingly, context, condition information, which are given little weight or are not included when an AI algorithm is trained, may be effectively analyzed, so that learning efficiency and recognition performance of the AI algorithm can be enhanced.

The technical concept of the present disclosure may be applied to a computer-readable recording medium which records a computer program for performing the functions of the apparatus and the method according to the present embodiments. In addition, the technical idea according to various embodiments of the present disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the art without departing from the scope of the present disclosure claimed in claims, and also, changed embodiments should not be understood as being separate from the technical idea or prospect of the present disclosure.

1. A GT dataset generation method comprising the steps of:
acquiring and storing vehicle data;
acquiring and storing sensor data generated at a sensor installed in a vehicle; and
generating and storing context information which is information regarding a context at a time when the data is acquired.

2. The GT dataset generation method of claim 1, wherein an area in which the context information is stored is positioned on an upper area of an area in which the vehicle data is stored, an area where the sensor data is stored, and an area where an annotation is stored.

3. The GT dataset generation method of claim 1, wherein the context information is information that is referred to when the context at the time when the data is acquired is reconstituted.

4. The GT dataset generation method of claim 3, wherein the step of generating and storing the context information comprises generating the context information by synthetically analyzing the sensor data.

5. The GT dataset generation method of claim 3, wherein the context information comprises information regarding an address of an administrative district where the data is acquired, a road environment, a date, a weather condition.

6. The GT dataset generation method of claim 1, wherein the vehicle data comprises information regarding the vehicle and information regarding sensors mounted in the vehicle, and
wherein the step of storing the sensor data comprises synchronizing the sensor data sensed by the sensors through at least one of interpolation, up-sampling and down-sampling, and storing the sensor data.

7. The GT dataset generation method of claim 1, further comprising a step of acquiring and storing GT information regarding the sensor data,
wherein a step of acquiring and storing an annotation comprises acquiring the GT information which is manually correctable after generating by using an AI network which receives sensor data and infers GT information.

8. A GT dataset generation system comprising:
an acquisition unit configured to acquire vehicle data and to acquire sensor data generated at a sensor installed in a vehicle;
a processor configured to generate context information which is information regarding a context at a time when the data is acquired; and
a storage unit configured to store the vehicle data and the sensor data acquired through the acquisition unit, and the context information generated by the processor.
